(19) United States
(12) Patent Application Publication
(10) Pub. No.: US 2011/0251712 A1
(43) Pub. Date: Oct. 13, 2011

(54) SYSTEM FOR TRACKING SYSTEM PROPERTIES

(75) Inventors: Jochen Schlüter, Dortmund (DE); Markus Reifferscheid, Korschenbroich (DE); Ina Hüllen, Dusseldorf (DE)

(73) Assignee: SMS SIEMAG AKTIENGESELLSCHAFT, D??sseldorf (DE)

(21) Appl. No.: 13/130,227

(22) PCT Filed: Nov. 20, 2009
(86) PCT No.: PCT/EP2009/008287

§ 371 Date: Jun. 27, 2011

(30) Foreign Application Priority Data
Nov. 20, 2008 (DE) 10 2008 058 354.5

(51) Int. Cl. G06F 19/00

(52) U.S. Cl. 700/108

(57) ABSTRACT

The invention relates to a device for actively tracking specific data on systems or the components of a metallurgical system, characterized in that at least one readable and writable memory medium for the specific data is fixedly connected to each component, and the specific data are modifiable periodically and/or on the basis of input. In addition, the invention relates to a metallurgical system, in particular an integrated foundry or a mini-mill, comprising at least one device according to the invention. Finally, the invention relates to the use of at least one device according to the invention in an electric steel mill or a converter steel mill and/or in systems of secondary metallurgy and/or in casting plants, in particular continuous casting machines, and/or in molten steel transport units and/or in furnace systerms and/or in hot and cold rolling mills and/or in rolled stock treatment systems, in particular strip treatment systems.

### I. FIELD OF THE INVENTION

The invention relates to a device for actively monitoring specific data concerning plants or their components in a metallurgical plant, particularly the use of such a device in an electric or converter steel mill, of secondary metallurgy or a casting plant, in liquid steel transport units or furnace plants, in hot and cold rolling plants or also strip treatment plants.

### II. State of the Art

Metallurgical plants, such as integrated steel works or minimills, consist of a number of plants which in cooperation with each other have the object of producing a high quality product with the highest possible plant utilization. In the respective plant types of the total system, there are, in turn, structural groups, consisting of structural subgroups and individual components. Mentioned only as an example is a continuous casting plant which consists of a supply container for the liquid steel, a tundish, various stopping rods and immersed outlets, at least one mold as well as a strand guidance with an appropriate cooling group arranged underneath the respective mold.

For reasons of material economics, quality assurance, and maintenance, it is required that all components of each subgroup or structural group or of a total system with all its specific data, for example, of their geometry, their physical, mechanical and chemical properties, their functional scope and their capability of functioning, also with respect to the historical and actual use information, such as duration of use, the localization with respect to time, the load collectives and wear conditions are regularly and permanently monitored.

Such data collection and follow up as well as maintenance of the data has been found to be especially time and cost consuming as well as to be subject to errors. Therefore, there has been the wish for a long time already to be able to carry out an extensive automation of the above-described functions.

### III. Object of the invention

Therefore, it was an object of the invention to make available a device for the active monitoring of specific data in plants or their components of a steel works which, compared to the prior art, has a low susceptibility to errors and a low expenditure of man hours.

In the sense of the invention, this object is met by a device which includes the features of claim 1, a metallurgical plant, comprising the features of claim 12, as well as the use of such a device according to the invention, as defined in claim 13. Advantageous further developments of the invention are defined in the dependent claims.

### IV. SUMMARY OF THE INVENTION

In the sense of the invention, each component of the metallurgical plant has at least one recordable and readable storage medium for the specific data, wherein these specific data are changeable periodically and/or dependent on inputs.

Preferably, the active monitoring of properties of total plants, individual plants or single plant components in the steel producing industry takes place with the utilization of wireless information transmission (RFID—Radio Frequency Identification), for example, by transmitting signals in the microwave range. This provides the possibility of reading the specific data preferably fully automatically and/or to revise the data and, moreover, to make them available to central data storage means and/or process control units.

In the sense of the invention, the total system of the metallurgical plant and the system for monitoring properties in a building structure of structural groups, these structural groups, in turn, consist of structural subgroups and the structural subgroups, in turn, of individual components. In the sense of the invention, the individual components as well as the structural groups are fixedly connected to a recordable and readable storage medium, especially RFID-chips. The information present in the storage media are, for example, a component recognition, as well as the historical properties of the individual component or structural group, wherein this information can preferably be generated or called up at physically different locations. Thereby the combination and/or adherence of several components to a higher level, is preferably modular, in order advantageously to support the material planning and plant operation as well as the maintenance thereof.

The total system as well as the individual structural groups, structural subgroups and plant components are subject in metallurgical plants to environmental influences, as well as work processes which conventionally have the effect that the properties of the individual elements of the total system or the total system itself is changed over time as well as depending on particular actions.

In this connection, only as an example is being mentioned the usual plant wear or material usage. However, in material planning and process control, these property changes are characteristic values which are of greatest importance in order to be able to ensure a secure work sequence of the total system without unnecessary outage times and a uniform quality of the product.

In the sense of the invention, therefore, the total system, the structural groups, the structural subgroups and individual components with respect to their combination and properties are generally locally placed on the storage medium and can be read by the latter as desired. For this purpose, writing or reading units can be provided stationary when the plant components are mobile or with stationary plant components can also be mobile.

Due to the communication capability of the storage medium with the writing or reading unit, the specific data or information can be placed locally on the storage medium as well as at least partially on a central data storage means. In particular, in the case of the use of central data storage, the storage capacity of the storage medium can be limited to the necessary minimum.

The central data storage as well as the central process control unit are preferably connected to control units of the material supply and/or the replacement part procurement and/or the production planning and/or the maintenance, in order to thereby advantageously increase the automation degree of the metallurgical plant or at least of parts thereof.

In an advantageous further development of the invention, the storage medium is an RFID-unit which can be recorded on and read at least once. Such a recording capability and reading capability should preferably be available at least at two different locations, and especially preferred in a wireless manner. The data which have been read in can be read into the data storage unit of the RFID-chip coded as well as uncoded, wherein coded data can be reduced just because of the fact that the data quantities can be reduced through the coding and the storage unit can thereby be limited to a necessary minimum.

The recording capability can thereby take place variably by recording over previously pre-entered data, or by attaching new data sets to already recorded and existing data sets.

The fixed connection of the storage medium of the respective components is realized in the sense of the invention by generally avoiding an unintentional separation of the storage medium from the plant components. However, also conceivable is an embodiment in which the storage medium can, for example by releasing a locking means, be separated from the component as desired as well as reconnected to it. As a result, an exchange, when the storage medium fails, or when changes of the use of the component and corresponding changes of the characterization are advantageously supported.

It is particularly preferred if the storage medium, which is fixedly connected to the component, as encapsulated relative to the surroundings, i.e., is preferably heat and moisture insulated. As a result, the use in metallurgical plants is particularly advantageously reinforced and a failure of the storage medium because of a contact with the harmful surrounding conditions frequently occurring in metallurgical plants is substantially avoided.

Particularly preferred is a wireless recording and reading capability of the storage medium, in particular by means of wireless transmissions in the microwave range. As a result, global as well as local communication paths are created between the RFID/microprocessor units and the individual components, the structural groups, plants or also with data bank systems which operate for all plants, as well as the connected internal or external maintenance and repair operations and/or firms for material and replacement part procurement and the production planning are significantly improved. It is then possible to communicate locally between the RFID-tags or microprocessor units integrated in the plant components and integrated stationary or mobile reading and writing units.

Particularly preferred as concrete examples of use describable and readable storage media for this specific data for each of the components are:

1. Pig iron and steel works ladles, torpedo carriage tracking, particularly the ladle supply, ladle stations in the steelworks and cranes. The fields of use are in this connection are the recognition of components of supply linings, the slide and AMEPA-unit which are connected in the sense of the invention each with at least one RFID-chip which contains specific data for the individual components. The specific data can in this connection be the localization with respect to place and time of the individual components in the steelworks, particularly waiting periods, heating periods, periods of use and use parameters, and, thus, the monitoring of the state in the cycle of wear, the thermal state, the residual quantities as well as any formation of skull.

2. Continuous casting molds, particularly the mold workshop and the casting plant itself. In the sense of the invention, RFID-chips may serve for the component recognition (structural) of water boxes, mold plates and thermoelement equipment. A localization with respect to location and time in the casting plant can be carried out, particularly the times of operation, the operating parameters, used quantities and thermal and mechanical load collectives, so that the monitoring of the state in the wear cycle, particularly the number and reasons for remedial work, as well as the status of the thermal elements becomes possible. Analogeous applications in the field of continuous casting can also be present in the distributors and distributor carriages, the plug and slide mechanisms, the segments of the strand guidance as well as in the flame cutting machine.

3. Work rolls, particularly the roll workshop, and the rolling mill itself. In this connection, the component recognition and assignment of properties, particularly of the diameter, the grind as well as the surface roughness, may be stored in the RFID-chips. A local and time related localization in the rolling mill, in particular the times of use, the parameters of use, the quantity of use and the thermal and mechanical load collective can be reconstructed and the state of the wear cycle, particularly the numbers and reasons for remedial work on the work rolls, can be monitored.

4. Strip welding plants, particularly the strip plant and its maintenance operation. The component recognition and the assignment properties, particularly the welding knives and the welding electrodes can be placed in the RFID-chips. As a result, a local and time related localization of the components in the rolling mill, particularly the periods of use, use parameters, use quantities, as well as the electrical and mechanical load collectives, are ensured and the condition of the individual components in the work cycle is also observable in respect of preventive maintenance.

### 5. BRIEF DESCRIPTION OF THE DRAWINGS

The invention will in the following be explained with respect to the FIGS. 1 to 3 which in combination illustrate individual uses of the device according to the invention.

In the Figures:

FIG. 1 is a power point slide for the component recognition in the continuous casting plant;

FIG. 2 is a power point slide for the component recognition in the strand casting plant in connection with the sample of a mold;

FIG. 3 is a power point slide for ladle recognition.

### 6. MODES OF CARRYING OUT THE INVENTION

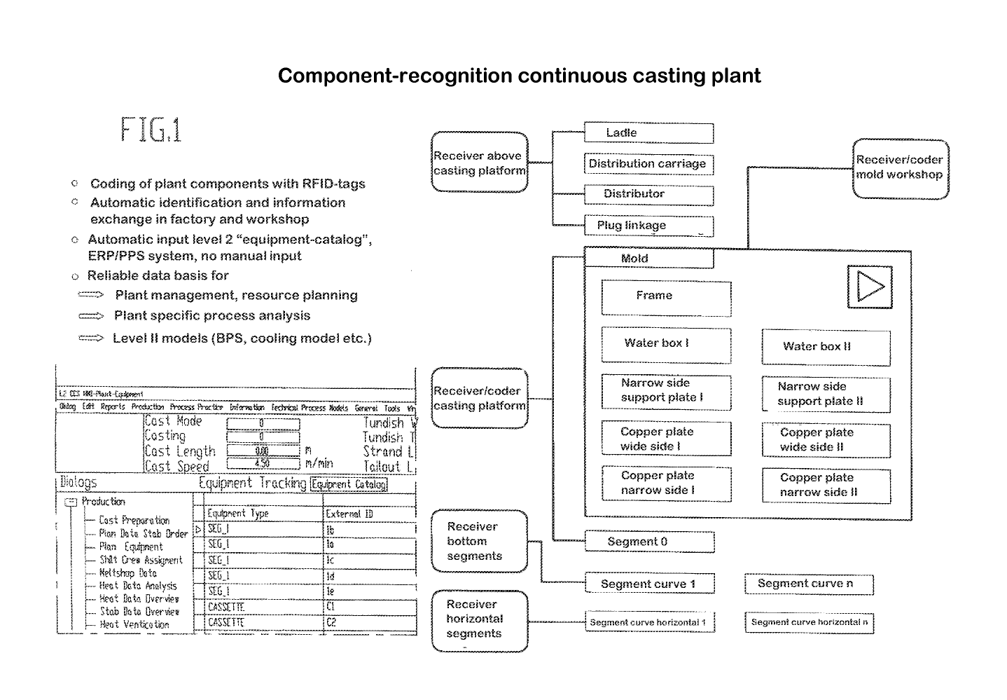

FIG. 1 shows as an example the component recognition according to the invention by means of an RFID-tag in a continuous casting plant and the automatic identification and the information exchange in factory and workshop. The RFID-tags connected to the individual components for the ladle, the distribution carriage, the distributor and the plug linkage are in communication with a receiver above the casting platform, while the RFID-tags for the mold, particularly the frame thereof, the various water boxes, the narrow side support plates, the copper plate wide sides and copper plate narrow sides are in communication with a receiver/coder in the mold workshop. The RFID-tags mentioned last and connected to the mold are together with RFID-tags additionally in communication with a receiver/coder on the casting platform at least at the first support segment underneath the mold. RFID-tags at the support segments in the curved portion of the strand guidance underneath the mold are in communication with a receiver at the bottom segments and RFID-tags at the support segments downstream of the curved segments in the horizontal strand guidance portion are in communication with a receiver on the level of the horizontal segments. Preferably, an automatic input of the characteristics of the equipment catalogue takes place from the IRP-PPS-system and without manual input, so that a reliable data basis is obtained for the plant management, the resource planning, the plant specific process analysis as well as level II models.

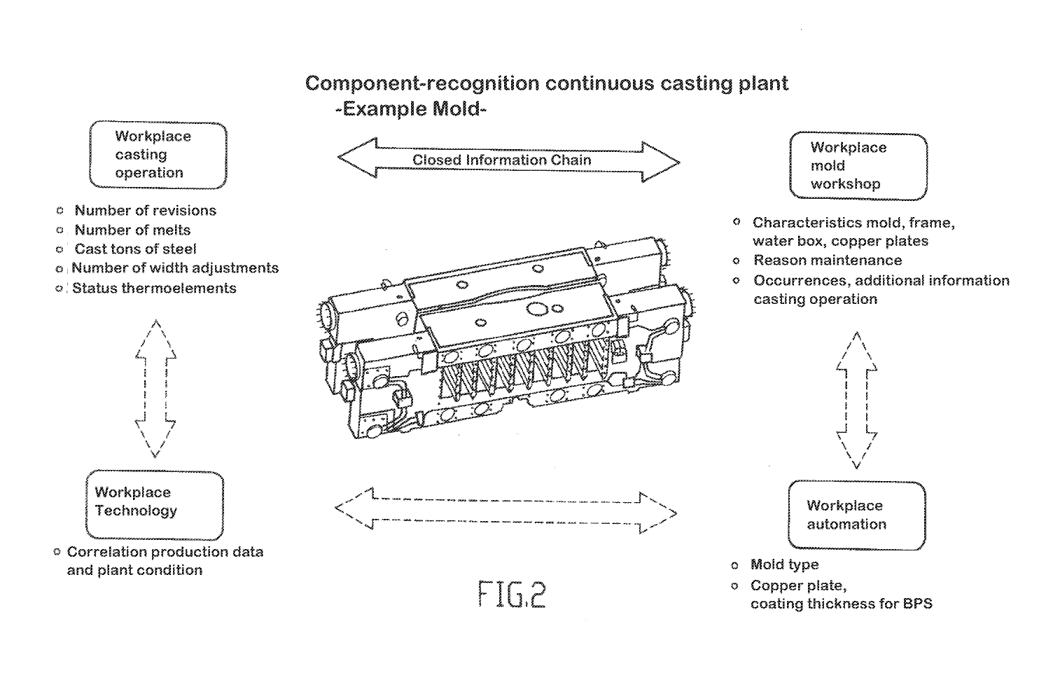

FIG. 2 shows in connection with an example of the mold itself the closed information chain between the workplace “casting operation”, the workplace “mold workshop”, the workplace “automation”, and the workplace “technology” with the individual specific data of the components of the mold assigned to individual workplaces. At the workplace “mold workshop” these are the characteristics of the mold, the frame, the water boxes, as well as the copper plates, any reasons for additional information for serving specific occurrences as well as additional information for the casting operation. At the workplace “automation”, the specific data are particularly the mold type, the copper plate and the feeding thickness for BPS. At the workplace “technology”, in turn, the specific data encompass a correlation between the production data and the plant condition and in the workplace “casting operation”, the specific data encompass in particular the number of already occurred overworkings, the number of cast melts, the quantity of steel already cast in tons, the number of width adjustments carried out in the mold as well as the status of the used thermal elements.

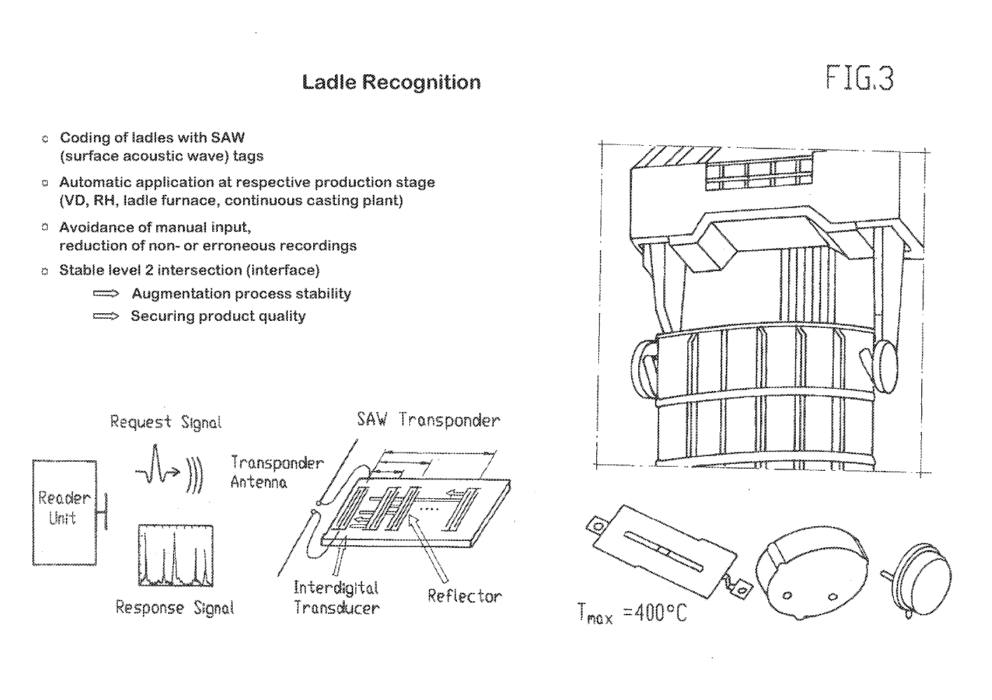

FIG. 3 shows finally shows in the area at the lower left a schematic illustration of a so-called SAW-transponder which utilizes acoustic surface waves (surface-acoustic-wave SAW) and reflects the waves. In the area of the ladle recognition shown in this area, the ladles are coded with SAW-tags and the ladles can as a result of the use of the storage media automatically apply for the respective production stage, for example, at the VD-plant, the RH-plant, the ladle furnace or the continuous casting plant. As a result, a manual input of specific data is avoided, so that inputs not carried out or erroneously carried out are reduced. A stable level II intersection point is created which increases the process stability and ensures the productivity. Moreover, in the bottom right portion of the Figure, various configurations which are already available of heat resistant SAW-tags with a maximum temperature of operation of 400 degrees Celsius are shown, which, with a suitable placing at the ladle and possibly with the use of a suitable encapsulation are found to be resistant against environment temperatures and moisture levels which are common in metallurgical plants.

1-10. (canceled)

11. An active data monitoring device of plants or components in a metallurgical plant, comprising: at least one central data storage; at least a central process control unit; and at least one recordable and readable storage medium for specific data concerning the plants or their components fixedly connected to each component, wherein the specific data are changeable periodically and/or input dependently, wherein the central data storage and the process control unit are connected to control units of material supply and/or replacement part procurement and/or production planning and/or maintenance economics.

12. The active monitoring device according to claim 11, wherein the specific data comprise a characterization of the component or of component groups.

13. The active monitoring device according to claim 11, wherein the specific data comprise historic properties.

14. The active monitoring device according to claim 13, wherein the historic properties include times of use and wear conditions.

15. The active monitoring device according to claim 11, wherein the specific data describe properties of the respective component or of the contents thereof, wherein the properties are at least one of the properties selected form the group consisting of: physical properties, mechanical properties and chemical properties.

16. The active monitoring device according to claim 11, wherein the at least one storage medium is an RFID-chip.

17. The active monitoring device according to claim 16, wherein the RFID-chip is connected to a microprocessor unit.

18. The active monitoring device according to claim 11, wherein the at least one storage medium is encapsulated relative to ambient surroundings.

19. The active monitoring device according to claim 18, wherein the at least one storage medium is insulated against heat and moisture.

20. The active monitoring device according to claim 11, wherein communication with the storage medium, manely writing and/or reading of the storage medium, is effected by microwave transmission.

21. A metallurgical plant, particularly an integrated metallurgical factory or minimill, comprising at least one active monitoring device having at least one central data storage; at least a central process control unit; and at least one recordable and readable storage medium for specific data concerning the plants or their components fixedly connected to each component, wherein the specific data are changeable periodically and/or input dependently, wherein the central data storage and the process control unit are connected to control units of material supply and/or replacement part procurement and/or production planning and/or maintenance economics.

22. A method for monitoring plants or components in a metallurgical plant, comprising the steps of: providing at least one central data storage; providing at least a central process control unit; fixedly connecting to each component at least one recordable and readable storage medium for specific data concerning the plants or their components; changing the specific data periodically and/or input dependently; and communicating information from the central data storage and the process control unit to control units of material supply and/or replacement part procurement and/or production planning and/or maintenance economics.
